(19) United States
(12) Patent Application Publication
(10) Pub. No.: US 2010/0175358 A1
(43) Pub. Date: Jul. 15, 2010

(54) Haymaking implement for displacing crop lying on the ground

(75) Inventors: Alfonsus Jacobus VAN DEN ENGEL, SCHIEDAM (NL); Bart VAN DER LELIJ, ABBENBROEK (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: LELY PATENT N.V., MAASSLUIS (NL)

(21) Appl. No.: 12/732,331

(22) Filed: Mar. 26, 2010

Related U.S. Application Data
(63) Continuation of application No. PCT/NL2008/000152, filed on Jun. 19, 2008.

(30) Foreign Application Priority Data
Sep. 28, 2007 (NL) 1034442

(51) Int. Cl. A01D 80/02; A01D 78/08

(52) U.S. Cl. 56/370

(57) ABSTRACT

A haymaking implement for displacing crop lying on the ground has a rotor and at least one tine arm, wherein the tine arm is pivotable with respect to the rotor about an associated pivot axis, for movement between a gripping position for gripping and taking along crop lying on the ground and a release position for releasing the crop. The tine arm has an outer arm portion carrying a plurality of tines, wherein each tine comprises a tine point for contact with the crop. In the gripping position, an innermost tine point positioned relatively closest to the rotor axis is located on or in front of the pivot axis with respect to the direction of rotation (R), while an outermost tine point positioned relatively distant from the rotor axis is located behind the pivot axis.

### CROSS REFERENCE TO RELATED APPLICATIONS

This application claims priority from Dutch application No. 1034442 filed on 28 Sep. 2007 and is a continuation in part of PCT International Application No. PCT/NL2008/000152 filed on 19 Jun. 2008, the contents of both of which are hereby incorporated by reference in their entirety.

### BACKGROUND OF THE INVENTION

1. Field of the Invention

The invention relates generally to haymaking implements for displacing crop lying on the ground and more particularly to a haymaking implement comprising a rotor having arms which are rotatable about an associated pivot axis.

2. Description of the Related Art

Haymaking implements are known comprising rotors that are rotatable about generally upstanding axes. The rotors are provided with arms which are themselves rotatable about an associated pivot axis. Tines are fastened on the ends of these arms. The outer end of an arm may be obliquely disposed relative to an inner portion. Owing to this, the outer part of the arm will be lifted to a greater extent than the inner part and an improved swath formation may be obtained. An example of a device that operates in this manner is given in EP0979600.

Despite the above-mentioned improvements, in practice, the swath formation is still sometimes found to be lacking. In particular, swath formation may be insufficiently accurate.

### BRIEF SUMMARY OF THE INVENTION

The present invention addresses these problems by providing a haymaking implement by which an improved swath formation is obtained, comprising at least one rotor which is rotatable about an upwardly orientated rotor axis in a direction of rotation (R); at least one tine arm, wherein the tine arm is pivotable with respect to the rotor about an associated pivot axis, for movement between a gripping position for gripping and taking along crop lying on the ground and a release position for releasing the crop, the tine arm comprising an outer arm portion; a plurality of tines provided on the outer arm portion, wherein each tine comprises a tine point for contact with the crop and, in the gripping position, an innermost tine point positioned relatively closest to the rotor axis is located on or in front of the pivot axis with respect to the direction of rotation (R), while an outermost tine point positioned relatively distant from the rotor axis is located behind the pivot axis.

In one particular embodiment, the invention provides a haymaking implement for displacing crop lying on the ground, comprising at least one rotor which is rotatable about an upwardly orientated axis in a direction of rotation and which is provided with at least one tine arm, wherein the tine arm is pivotably fastened to the rotor about an associated pivot axis, wherein the tine arm comprises an inner arm portion and an outer arm portion having a plurality of tines, wherein the tine arm is mechanically controllable in such a manner that the position of the tines during operation varies cyclically between a gripping position for gripping and taking along crop lying on the ground and a release position for releasing the crop, wherein each tine comprises a tine portion having a tine point for contact with the crop, a fastening portion for fastening on the tine arm and a spring portion which forms a flexible connection of the fastening portion to the tine portion, characterized in that the outer arm portion is connected to the inner arm portion by means of a curve which is shaped in such a manner that, viewed in vertical projection, at least the inner tine point of the tine arm, in the gripping position, is located on or in front of the pivot axis when viewed in the direction of rotation, while at least the outer tine point of the tine arm, in the gripping position, is located behind the pivot axis. In this case, by the pivot axis is meant the whole line about which the tine arm pivots, thus including the prolonged part thereof.

The advantage of such a haymaking implement, especially of such a tine arm construction, is that the control of in particular the inner tine points, i.e. the inner tines, improves, while the positive properties of the outer tine point(s) are maintained. It is found that the so-called curve path sensitivity of especially the inner tines has a great influence on the precision of the tines when releasing crop. All this will be explained below in further detail, with reference to FIG. 2 and its description. In the following, reference to “in front of” in the context of the tine arm is understood to refer to the direction of rotational movement of the tine arm around the rotor axis and not to the direction of movement of the implement.

In order to pivot the tine arm between the gripping position and the release position, there is usually applied a curve path, in which an end of the tine arm or a part connected thereto, such as a lever, is guided. This curve path has a substantially flat part, for the gripping position, and an obliquely inclined part, for the release position, or vice-versa if desired. In order to reduce forces on the tine arm during displacement, the transition between the two parts of the curve path is rounded. This means that there is a certain transition between the gripping position and the release position, wherein the end of the tine arm, or of the portion connected thereto, is located in the transition part of the curve path. Here, the tine arm will start pivoting. How quickly an effective release position of the tine is attained depends, in this case, on the position of the tine point relative to the pivot axis, viewed in vertical projection. If the tine point is located behind the vertical projection of the pivot axis, the point will rise relatively quickly, and will thus also release relatively quickly. By positioning the inner tine point, according to the invention, at least on or in front of the vertical projection of the pivot axis, said tine point will not or hardly rise at the beginning of the pivoting motion. When the end of the tine arm is located in the sharply rising part of the curve path, the pivoting motion will take place more quickly, and the effective release position will thus be attained more quickly. This means that the release accuracy for the tine (point) in question will increase. Especially for the inner tine (point) this is important, because the latter determines the inner boundary of the swath. For the outer tine (point) it is the case that, if the exact moment of release is not known, this does not or hardly lead to problems in relation to release accuracy. For, this tine (point) will always release somewhere on the swath to be formed, while, moreover, a swath board will usually be provided at the outer side of the swath.

Favorable embodiments are described in the sub claims. In particular, in the gripping position, the inner tine point of the tine arm is located in front of the pivot axis when viewed in the direction of rotation. Hereby it is even better ensured that said inner tine point will not start to rise slowly already at the beginning of the pivoting motion. The tine point will even first move a little in the direction of the ground. However, this is not a problem owing to, inter alia, the resilient properties of the tines. It is pointed out here that the properties for the outer tine point may also hold for one or more neighboring and more outwardly located tine points, of course to an extent that decreases with distance. The relative importance of accurate release behavior for the tines also decreases for more outward positions.

In particular, in the gripping position, for at least one of the tine points, and preferably for all the tine points, the incremental upward displacement in the case of rotation about the spring axis is greater than zero. If the tine hits an obstacle, such as a stone, the arm will deflect under spring pressure and rotate about the centre of the winding. This is called obstacle protection. Right at the first contact with an obstacle, such as a stone, the tine will react by rotation about the axis of symmetry of the spring and will perform, according to the invention, as a result thereof an initial motion having a vertical upward component. As a result thereof, the tine will move upward quickly and it will easily be possible to avoid the obstacle.

In a preferred embodiment, in the gripping position, for at least one of the tine points, and preferably for all the tine points, the incremental upward displacement in the case of rotation about the spring axis is greater than in the case of rotation about the pivot axis. The obstacle protection is thus even more efficient than the pivoting motion about the pivot axis which will occur in any case, but later. The transition from the gripping position to the release position takes place by means of a rotation about the pivot axis. At the beginning of the pivoting motion, the motion of the tine point will have no vertical component or a much smaller vertical component. As a result thereof, at the transition to the release position, the tine point will maintain for a relatively long time substantially the same position as in the complete gripping position, and will subsequently pass very quickly to the release position. In fact, the obstacle protection and the rapid transition from the gripping position to the release position are thus effectively separated.

Viewed in the direction of rotation, the centre of the spring portion of at least one of the tines is advantageously located in front of the pivot axis. This is a simple manner of ensuring that the incremental displacement of the tine point is orientated upwardly when an obstacle is met.

Viewed in the direction of rotation, the centre of the spring portion of at least one of the tines may also be located higher than the pivot axis. A long, flexible tine point is then provided.

Advantageously, the distance between the tine point and the spring axis is smaller than the distance between the tine point and the pivot axis at the position of the tine point. In this, alternative, embodiment, there is, on the contrary, provided a relatively short tine which, however, in particular if the centre of the spring portion is positioned in front of the pivot axis, has an excellent obstacle protection.

In the above-mentioned embodiments, it is obvious that the pivot arm, in particular the curve and the tine arm portions, is designed in such a manner that the tine points are actually operative in the gripping position.

In particular, the spring portion is connected to the pivot arm by means of a connecting piece, and the spring axis and the outer arm portion are located at a mutual distance of, preferably, at least the diameter of the spring portion. Thus, in this case, the spring portion does not surround the pivot arm. This provides even more possibilities of disconnecting the obstacle protection from the actual pivoting motion. Alternatively, the spring portion may surround the pivot arm, in which case the advantage of lesser contamination is provided. Moreover, in the case of breakage in the spring portion, the remaining parts will not come loose from the tine arm.

Furthermore, it is advantageous if the outer arm portion and the inner arm portion form an integral whole. This enables an inexpensive and simple production of the tine arm, starting from a tube.

In particular, the spring portions of two neighboring tines form an integral whole. In such a construction, it is possible to connect a plurality of tines to the tine arm by means of one single fastening.

### BRIEF DESCRIPTION OF THE DRAWINGS

The features and advantages of the invention will be further appreciated upon reference to the following drawings, in which:

FIG. 1 is a side view of a haymaking implement according to the invention comprising a rotor having controlled arms;

FIG. 2 is a side view of an arm of a haymaking implement according to the invention, and

FIG. 3 is a view in vertical projection in the gripping position of part of an arm of a haymaking implement according to the invention.

### DESCRIPTION OF ILLUSTRATIVE EMBODIMENTS

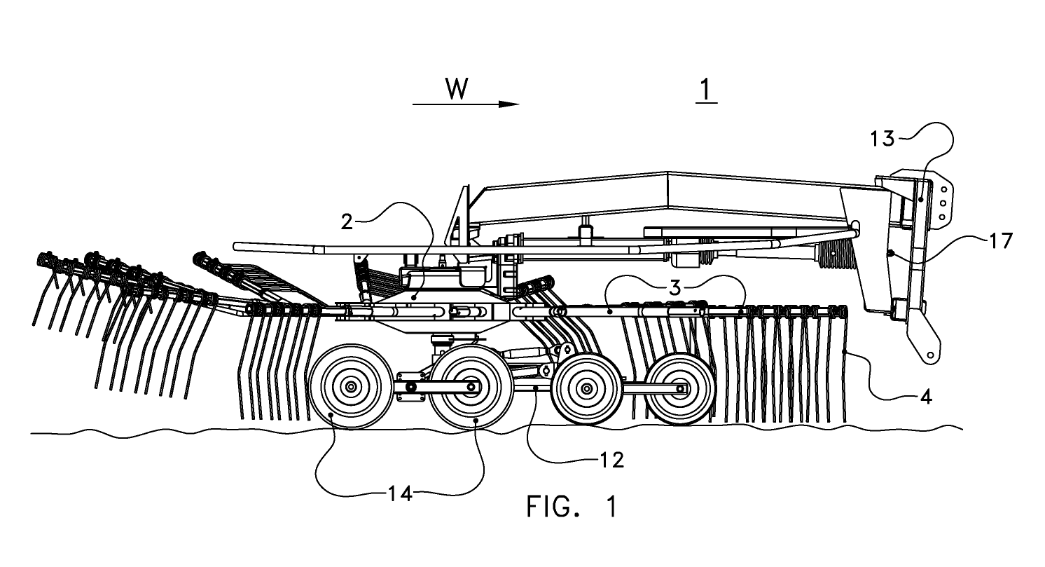

The following is a description of certain embodiments of the invention, given by way of example only and with reference to the drawings. Referring to FIG. 1, a haymaking implement 1 for displacing crop lying on the ground is shown, comprising at least one rotor 2 which is rotatable about an upwardly orientated axis and which is provided with at least one tine arm 3, wherein the tine arm 3 is pivotably fastened to the rotor 2 about an associated pivot axis 5, wherein the tine arm 3 comprises an inner arm portion 15 and an outer arm portion 16 having a plurality of tines 4, wherein the tine arm 3 is mechanically controllable in such a manner that the position of the tines 4 during operation varies cyclically between a gripping position for gripping and taking along crop lying on the ground and a release position for releasing the crop, wherein each tine 4 comprises a tine portion 6 having a tine point 18 for contact with the crop, a fastening portion 7 for fastening on the tine arm 3 and a spring portion 8 which forms a flexible connection of the fastening portion 7 to the tine portion 6, wherein the outer arm portion 16 is connected to the inner arm portion 15 by means of a curve which is shaped in such a manner that, viewed in vertical projection, at least the inner tine point 18 of the tine arm 3 is located, in the gripping position, viewed in the direction of rotation R, on or in front of the pivot axis 5, while at least the outer tine point 18 of the tine arm 3 is located, in the gripping position, behind the pivot axis 5. For the sake of clarity, not all the tines 4 are shown in this view. At the front side the haymaking implement 1 is fastened to a not shown tractor by means of a trestle 13. The rotor 2 is drivable via the tractor via the coupling shaft 17 and is supported on the ground via a wheel set 12 having a plurality of wheels 14. The haymaking implement 1 is of the so-called controlled type having one rotor. Viewed in the direction of operation W, at the front side of the rotor 2, the tines 4 are located vertically in the gripping position, while at the rear side the tines 4 are orientated substantially horizontally in the release position. When the rotor 2 is rotating, the crop lying on the ground at the front side is taken along by the tines 4 to the release side at the lateral side. At this release side, the tine arms 3 rotate in a more horizontal position to the release position and release the crop taken along into a swath.

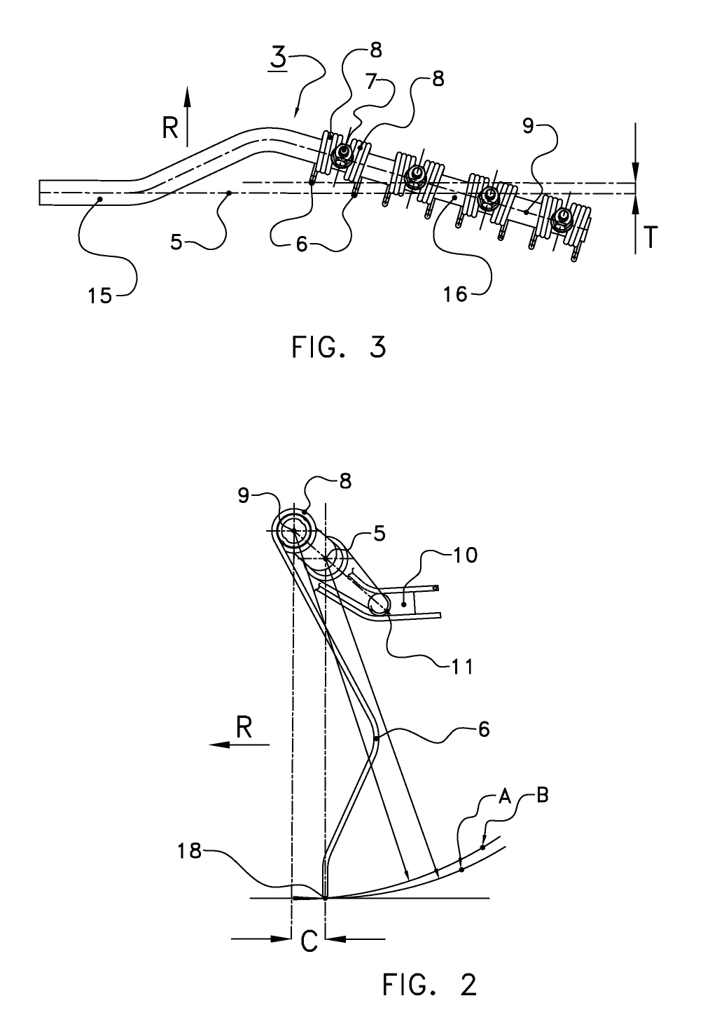

FIG. 2 shows a detail of the haymaking implement 1, namely the tine arm 3 to which a tine 4 is fastened. There is depicted a curve path 10 known per se in which a running wheel 11 runs. Owing to the fact that the running wheel 11 passes through the curve path 10 during rotation of the rotor 2, it transmits, in a manner known per se via a lever, a rotational motion to the tine arm 3 as a result of which the latter will pivot about the axis of rotation 5. The tine arm 3 comprises an inner arm portion 15 and an outer arm portion 16 (FIG. 3), the inner arm portion 15 being at one side rotatably connected to the rotor 2 and being at the other side connected to the outer arm portion 16 to which the tine 4 is fastened and the outer arm portion 16 being disposed beveled relative to the inner arm portion 15. The components of the tine 4, i.e. the spring portion 8, the fastening portion 7 and the tine portion 6, are made of flexible steel so that it is possible for the tine to perform a rotational motion about the spring axis 9. In the embodiment shown, this spring axis 9 coincides with the axis of symmetry of the outer arm portion 16.

When the tine portion 6 comes into contact with an obstacle, such as a stone, the tine portion 6 will move rearward opposite to the direction of rotation R and rotate about the spring axis 9. In this case the tine point will pass through the curve B and gradually move upward. In the case of sufficient rearward deflection, the tine point will at a given moment be lifted to a sufficient extent to allow the obstacle to pass thereunder. This capacity to avoid an obstacle is called the obstacle protection.

During passing through the curve path 10 from the gripping position to the release position the tine arm 3 will pivot about the pivot axis 5 and pass through curve A. For a proper functioning of the haymaking implement 1 it is necessary to have the transition from the gripping position to the release position take place as abruptly as possible. This may take place according to the invention by having curve A co-operate with the tine point position in such a manner that the transition from the horizontal portion to the oblique portion takes place when the incremental motion upon pivoting about the pivot axis is small. The quicker motion in the oblique part of the curve path will thus coincide with the part of the pivoting motion which has a relatively great incremental upward displacement. In the gripping position, viewed in the direction of rotation R of the rotor 2 and viewed transverse to the pivot axis 5, the tine point is aligned with the pivot axis 5. This is indicated by the vertical line through the pivot axis 5 and the tine point. This leads to the incremental displacement when entering the curve (see the position of the running wheel) being substantially zero and the tine point first still moving horizontally, which is advantageous to a relatively long gripping action.

As shown in FIG. 2, the curve B is steeper in vertical direction than the curve A and the obstacle protection is relatively strong.

In vertical projection, the distance C between the spring axis 9 and the vertical plane through the pivot axis 5 for this tine point is greater than the inner radius of the spring portion 8. It has been found in practice that this distance ensures a sufficient difference between the curves A and B.

FIG. 3 shows a particular embodiment of a tine arm 3 having four tines. In this case, the haymaking implement 1 comprises a second tine portion 6 which is fastened to the inner side of the rotor 2 and has a second tine point, which second tine point, in the gripping position, viewed in the direction of rotation R of the rotor 2 and viewed transverse to the pivot axis 5, is located on the pivot axis 5. The haymaking implement 1 further comprises a second tine portion 6 which is fastened to the inner side of the rotor 2 and has a second tine point, which second tine point, in the gripping position, viewed in the direction of rotation R of the rotor 2 and viewed transverse to the pivot axis 5, is located in front of the pivot axis 5. The spring axis 9 is at an angle to the perpendicular plane through the pivot axis 5. This angle is preferably between 5 and 20 degrees, and is more preferably approximately 15 degrees. In this construction, when moving from the gripping position to the release position, the inner tine point will initially move downward to some extent. However, the tine points which are the outer ones when viewed from the rotor axis, are located behind the pivot axis when viewed in the direction of rotation R. Owing to this, these tine points will move upward even more quickly. This prevents crop from being undesirably taken along from the already deposited swath by these outer tine points. A second effect of the fact that the spring axis 9 is at an angle to the perpendicular plane through the pivot axis 5, is that the outer arm portion 16 is orientated obliquely upwardly to some extent in the release position, as shown in FIG. 1. This ensures that the tines 4 will less quickly come into contact with the crop in the swath. This holds in particular for the outer tines, which is advantageous because a swath is usually highest at its outer side.

The invention is not limited to the described embodiment having one single rotor 2, but may comprise any number of rotors. In the case of a plurality of rotors, it may be advantageous to select the proportions in such a manner that the described effects are different per rotor 2. This may be necessary in the case that one rotor 2 should also displace the crop deposited by another rotor 2. Besides, the invention is not limited to the described tine having two identical tine portions 6, but the tine may also consist of one single tine portion 6 and of tine portions 6 which are different in shape and/or flexibility. The tine 4 may also be fastened to the tine arm 3 in such a manner that the spring portion 8 is positioned at some distance from the tine arm 3.

Thus, the invention has been described by reference to certain embodiments discussed above. It will be recognized that these embodiments are susceptible to various modifications and alternative forms well known to those of skill in the art. Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. Haymaking implement for displacing crop lying on the ground, comprising:
at least one rotor which is rotatable about an upwardly orientated rotor axis in a direction of rotation;
at least one tine arm, wherein the tine arm is pivotable with respect to the rotor about an associated pivot axis, for movement between a gripping position for gripping and taking along crop lying on the ground and a release position for releasing the crop, the tine arm comprising an outer arm portion;
a plurality of tines provided on the outer arm portion, wherein each tine comprises a tine point for contact with the crop and, in the gripping position, an innermost tine point positioned relatively closest to the rotor axis is located on or in front of the pivot axis with respect to the direction of rotation, while an outermost tine point positioned relatively distant from the rotor axis is located behind the pivot axis.

2. Haymaking implement according to claim 1, wherein, in the gripping position, the innermost tine point of the tine arm is located in front of the pivot axis with respect to the direction of rotation.

3. Haymaking implement according to claim 1, wherein each tine comprises a spring portion having a spring axis which forms a flexible connection between the tine point and the tine arm and, in the gripping position, an incremental upward displacement of at least one of the tine points on initial rotation about its spring axis is greater than zero.

4. Haymaking implement according to claim 3, wherein, in the gripping position, the incremental upward displacement of said at least one tine point in the case of initial rotation about the spring axis is greater than in the case of initial rotation about the pivot axis.

5. Haymaking implement according to claim 3, wherein the spring axis of said at least one of the tines is located in front of the pivot axis.

6. Haymaking implement according to claim 5, wherein the spring axis of said at least one of the tines is located higher than the pivot axis.

7. Haymaking implement according to claim 1, wherein each tine comprises a spring portion having a spring axis which forms a flexible connection between the tine point and the tine arm and, in the gripping position, an incremental upward displacement of all of the tine points on initial rotation about the spring axis is greater than zero.

8. Haymaking implement according to claim 7, wherein, in the gripping position, the incremental upward displacement of all the tine points in the case of initial rotation about the respective spring axis is greater than in the case of initial rotation about the pivot axis.

9. Haymaking implement according to claim 7, wherein the spring axes of the tines are located in front of the pivot axis.

10. Haymaking implement according to claim 7, wherein, the spring axes of the tines are located higher than the pivot axis.

11. Haymaking implement according to claim 1, wherein each tine has an articulation between the tine point and the tine arm and, in the gripping position, a distance between the tine point and the articulation is smaller than a distance between the tine point and the pivot axis.

12. Haymaking implement according to claim 3, wherein the spring portion is connected to the tine arm by means of a connecting piece, and in that the spring axis and the outer arm portion are located at a mutual distance of at least a diameter of the spring portion.

13. Haymaking implement for displacing crop lying on the ground, comprising at least one rotor which is rotatable about an upwardly orientated axis in a direction of rotation and which is provided with at least one tine arm, wherein the tine arm is pivotably fastened to the rotor about an associated pivot axis, wherein the tine arm comprises an inner arm portion and an outer arm portion having a plurality of tines, wherein the tine arm is mechanically controllable in such a manner that the position of the tines during operation varies cyclically between a gripping position for gripping and taking along crop lying on the ground and a release position for releasing the crop, wherein each tine comprises a tine portion having a tine point for contact with the crop, a fastening portion for fastening on the tine arm and a spring portion which forms a flexible connection of the fastening portion to the tine portion, wherein the outer arm portion is connected to the inner arm portion by means of a curved portion such that, viewed in vertical projection in the gripping position, at least an inner tine point of the tine arm is located on or in front of the pivot axis when viewed in the direction of rotation, while at least an outer tine point of the tine arm is located behind the pivot axis.

14. Haymaking implement according to claim 13, wherein, in the gripping position, the inner tine point of the tine arm is located in front of the pivot axis when viewed in the direction of rotation.

15. Haymaking implement according to claim 14, wherein, in the gripping position, for at least one of the tine points an incremental upward displacement in the case of rotation about the spring axis is greater than zero.

16. Haymaking implement according to claim 15, wherein, in the gripping position, for at least one of the tine points, the incremental upward displacement in the case of rotation about the spring axis is greater than in the case of rotation about the pivot axis.

17. Haymaking implement according to claim 16, wherein a centre of the spring portion of said at least one of the tines is located in front of the pivot axis.

18. Haymaking implement according to claim 17, wherein the centre of the spring portion of said at least one of the tines is located higher than the pivot axis.

19. Haymaking implement according to claim 18, wherein a distance between the tine point and the spring axis is smaller than a distance between the tine point and the pivot axis.

20. Haymaking implement according to claim 19, wherein the spring portion has a diameter and is connected to the tine arm by means of a connecting piece, and in that the spring axis and the outer arm portion are located at a mutual distance of at least the diameter of the spring portion.
